(19) United States
(12) Patent Application Publication
(10) Pub. No.: US 2018/0127257 A1
(43) Pub. Date: May 10, 2018

(54) DRINK PRODUCING APPARATUS WITH SPECIFIC ARRANGEMENT OF A CONDITIONING CONTAINER IN A DISPENSING CONTAINER AS WELL AS HOUSEHOLD REFRIGERATION APPARATUS AND A METHOD

(71) Applicant: BSH HAUSGERAETE GMBH, Muenchen (DE)

(72) Inventors: KUDRET BAYSAL, GIENGEN BRENZ (DE); DELIA HAHN, HEIDENHEIM AN DER BRENZ (DE); MARCEL KIRSCHEN, GERSTHOFEN (DE); ANDREAS KLEINER, DORNSTADT (DE); CHRISTIAN MAYERSHOFER, GUNDREMMINGEN (DE); BERND METTEL, HERBRECHTINGEN (DE); CARSTEN WEISS, GIENGEN (DE)

(21) Appl. No.: 15/346,767

(22) Filed: Nov. 9, 2016

(51) Int. Cl. B67D 1/07; B67D 1/00; B67D 1/08; F25D 23/12; F25D 11/00; F25D 11/02; B08B 9/032

(52) U.S. Cl. CPC B67D 1/07; B67D 1/0021; B67D 1/004; B67D 1/0057; B67D 1/0078; B08B 9/0321; B67D 1/0894; F25D 23/126; F25D 11/00; F25D 11/02; B67D 1/0858

(57) ABSTRACT

A drink producing apparatus includes a dispensing unit for dispensing liquid from the drink producing apparatus, a dispensing container, which is formed for receiving a liquid addable to a drink by the drink producing apparatus in a first liquid state, a conditioning container, in which the liquid can be conditioned into a second liquid state different from the first liquid state, wherein the conditioning container is arranged in the dispensing container at least in certain areas, the conditioning container comprises an outlet, which is formed for draining a liquid medium from the conditioning container, wherein the outlet is formed at a bottom of the conditioning container. The invention also relates to a household refrigeration apparatus and to a method.

### TECHNICAL FIELD

The invention relates to a drink producing apparatus with a dispensing container, which is formed for receiving a liquid addable to a drink by the drink producing apparatus. The drink producing apparatus moreover includes a dispensing unit, to which the dispensing container is connected for supplying the liquid from the dispensing container to the dispensing unit. Furthermore, the invention also relates to a household refrigeration apparatus with such a drink producing apparatus as well as to a method for cleaning a drink producing apparatus.

### PRIOR ART

From DE 196 15 106 A1, a method and a device for continuously producing soda water or soda-like water are known. A device is disclosed there, in which different liquids like lemonade, beer, wine can be present in different separate containers. Each container is connected to an own tap and is thus separated from the other container. Producing and dispensing a mixed drink of different liquids in the containers is not possible there in the interior of the system itself. Furthermore, the taps are far apart such that introducing liquids from different taps into a drinking vessel at the same time is not possible.

From WO 2007/141321 A2, a household refrigeration apparatus is known, which comprises a drink apparatus, which is formed for dispensing a drink at this household refrigeration apparatus itself.

Moreover, cold drink machines are also known, in which alcohol containing mixed drinks, for example cocktails, can be dispensed.

In known drink producing apparatuses for dispensing cooled drinks, mixing of the liquid jet with other additions upon dispensing is restricted.

Especially carbonized and thus liquids mixed with carbonic acid lose carbonic acid in filling into the vessel, whereby the quality of the drink is decreased.

Moreover, hygienic requirements are also to be accommodated. In known implementations, the liquid can heat in the lines of a line device and germ growth can occur.

### PRESENTATION OF THE INVENTION

It is the object of the present invention to provide a drink producing apparatus as well as a household refrigeration apparatus, in which the hygiene in the apparatus is improved and the quality of the drink to be dispensed is high. It is also the object of the invention to improve the cleaning of a conditioning container of the drink producing apparatus.

This object is solved by a drink producing apparatus, a household refrigeration apparatus and a method according to the independent claims.

An aspect of the invention relates to a drink producing apparatus, which comprises a dispensing unit for dispensing liquid from the drink producing apparatus. The drink producing apparatus comprises a dispensing container, which is formed for receiving a liquid addable to a drink by the drink producing apparatus in a first liquid state. The drink producing apparatus comprises a conditioning container, in which the liquid can be conditioned in a second liquid state different from the first liquid state, wherein the conditioning container is arranged in the dispensing container at least in certain areas. The conditioning container comprises an outlet, which is formed for draining a liquid medium from the conditioning container. This outlet is formed at a bottom of the conditioning container. By such a drink producing apparatus, completely filling and wetting the conditioning container with liquid medium, in particular cleaning fluid, can be achieved and moreover complete discharge or drain of this medium from the conditioning container can be achieved. Thereby, cleaning of the interior of the conditioning container is allowed, namely with residues of the cleaning fluid in the conditioning container as low as possible. Thereby, particularly high hygienic requirements are achieved. By the specific arrangement of the conditioning container to the dispensing container, thermal coupling between these two containers is also achieved. This advantageously then also allows the liquid introduced into the conditioning container being able to be cooled by the dispensing container since the liquid in the dispensing container is in particular cooled.

A further aspect of the invention provides that the drink producing apparatus comprises a dispensing mode, in which a liquid addable to the drink to be produced is contained in the dispensing container and in the conditioning container. The drink producing apparatus comprises a cleaning mode different from the dispensing mode, in which a cleaning fluid is contained in the dispensing container and in the conditioning container. The liquid medium is the liquid in the conditioning container in the dispensing mode.

In a further aspect of the invention, it is provided that the conditioning container comprises an electrically switchable valve for exhausting a gas contained in the conditioning container during a cleaning mode of the drink producing apparatus.

This electrically switchable valve can be arranged at a ceiling of the conditioning container. This advantageous position allows the conditioning container then being able to be completely filled with cleaning fluid and the gas present in the conditioning container then being able to completely escape.

In an advantageous implementation of the invention, the drink producing apparatus comprises a filling level sensor for capturing a filling level of a cleaning fluid in the conditioning container during a cleaning mode of the drink producing apparatus. Thereby, the addition of cleaning fluid can be very accurately monitored and a very preferred cleaning operation is allowed. The filing sensor is able to detect a filling level of the liquid in the conditioning container in the dispensing mode.

Preferably, the filling level sensor can be a filling level sensor operating in non-contacting or contactless manner. The filling level sensor can for example be an ultrasonic sensor or an optical sensor.

According to a further aspect of the invention, the drink producing apparatus comprises a decompression chamber for pressure reduction of the carbonized liquid from the conditioning container. The decompression chamber is connected to the conditioning container by a line part of a line device of the drink producing apparatus. The liquid is then correspondingly led into this line part. By such a decompression chamber, it is allowed that a carbonized liquid can also be dispensed. In particular if the second liquid state is a carbonized state, thus, the liquid in this second liquid state has a relatively high pressure, which is at about 5 bar. The dispensing of a liquid thus being under pressure via the dispensing unit is disadvantageous since severe splash and no continuous jetting of the liquid is effected. In order to avoid this, the decompression chamber is advantageous since the pressure of the liquid is considerably reduced in it, in particular is reduced to a value of about 3 bar.

According to a further aspect of the invention, the drink producing apparatus comprises a functional component, which is arranged at the conditioning container and which extends into the dispensing container. Furthermore, the drink producing apparatus comprises a cover, by which the functional component is covered in a partial area, which extends into the dispensing container. A functional component can for example be a line for leading liquid. However, a functional component can also be an electrical component like a sensor or the like. By such a coverage of specific partial areas of a functional component, further improvements with respect to the hygiene can be achieved. In this context, undesired deposits in these partial areas, which optionally would then be covered by liquid, can occur if a cover would not be present.

The drink producing apparatus comprises a line part of a line device, to which the dispensing container is connected for leading the liquid from the dispensing container to the conditioning container, wherein this line part opens into the conditioning container at the bottom of the conditioning container. This is a very advantageous implementation since the liquid, which is to be dispensed from the dispensing container in a dispensing mode, can thus be completely discharged. Undesired residues of this liquid in the dispensing container can thereby be avoided, whereby hygienic improvements can similarly be achieved.

A further aspect of the invention relates to a household refrigeration apparatus with a housing, in which a receiving space for food is formed. The household refrigeration apparatus comprises a drink producing apparatus. This drink producing apparatus comprises a dispensing unit for dispensing liquid from the drink producing apparatus. The drink producing apparatus comprises a dispensing container, which is formed for receiving a liquid addable to a drink by the drink producing apparatus in a first liquid state. The drink producing apparatus comprises a conditioning container, in which the liquid can be conditioned into a second liquid state different from the first liquid state. The conditioning container is arranged in the dispensing container at least in certain areas. The conditioning container comprises an outlet, which is formed for draining the liquid conditioned in the second liquid state from the conditioning container. This outlet is formed at a bottom of the conditioning container.

A further aspect of the invention relates to a method for cleaning a drink producing apparatus. The drink producing apparatus is provided with a dispensing unit for dispensing liquid from the drink producing apparatus in a dispensing mode of the drink producing apparatus. The drink producing apparatus is provided with a dispensing container for receiving a liquid addable to a drink by the drink producing apparatus in a first liquid state in a dispensing mode of the drink producing apparatus. Moreover, the drink producing apparatus is provided with a conditioning container, in which the liquid is conditioned in a second liquid state different from the first liquid state in a dispensing mode of the drink producing apparatus. The conditioning container is arranged in the dispensing container at least in certain areas. For cleaning the drink producing apparatus, a cleaning mode of the drink producing apparatus is set. In this cleaning mode, supply of a cleaning fluid into the drink producing apparatus is then performed. Thereto, the conditioning container is completely filled with the cleaning fluid. Subsequently, the cleaning fluid is then drained from the conditioning container via an outlet at a bottom of the conditioning container. By this configuration, an extensive and complete cleaning of the conditioning container in its interior is allowed. Moreover, the introduced cleaning fluid can also again completely and simply be removed from the conditioning container.

The conditioning of the in particular non-carbonized liquid into a carbonized liquid is performed in the conditioning container. The non-carbonized state of the liquid represents the first liquid state and the carbonized state represents the second liquid state.

Preferably, it is provided that the drink producing apparatus comprises a capsule with an addition medium separate from the dispensing container, which can then be added to the jet of the liquid in producing the mixed drink. Such an addition medium can be liquid, gelatinous or powdery. In this context, addition media individual both in taste and in color can then be present, which impart corresponding specifications to the mixed drink.

In particular, it is provided that the drink producing apparatus comprises at least one second dispensing container, which is formed for receiving a second liquid addable to the in particular cooled mixed drink by the drink producing apparatus, wherein this second dispensing container is connected to the dispensing unit of the drink producing apparatus for leading the second liquid from the second dispensing container to the dispensing unit, wherein the first liquid and the second liquid are mixed to the jet dispensed from the dispensing opening. In this configuration, thus, a mixed drink of two different liquids is already present at the dispensing opening, which can then in particular be mixed with the jet of the addition medium from the capsule.

It can be provided that a liquid, in particular the first liquid, is water or contains water and the second liquid is alcohol or contains alcohol.

In particular, the two liquids also have different freezing points.

In particular, the first dispensing container is cooled by a cooling device of the drink producing apparatus. The cooling device is in particular a refrigeration circuit. The refrigeration circuit in particular includes an evaporator thermally coupled to the dispensing container such that the dispensing container can be cooled by the cold energy of the evaporator and thus the first liquid in particular present in the dispensing container is then also cooled thereby.

In particular, the preferably present second dispensing container can also be cooled by the cooling device. Here too, the thermal coupling to a refrigeration circuit is in particular provided, which is preferably the refrigeration circuit, by which the first dispensing container is also cooled. Here too, it is preferably provided that the second dispensing container is thermally coupled to an own, separate evaporator and is cooled via the cold energy thereof. Especially if the two liquids have different freezing points, the cooling with separate cooling units, in particular separate evaporators, is advantageous to be able to individually adjust adequate temperatures without one of the two liquids freezing.

Furthermore, the invention also relates to a household refrigeration apparatus for storing and preserving food, which comprises a housing, in which a receiving space for food is formed. Moreover, the household refrigeration apparatus includes a drink producing apparatus according to the first independent aspect of the invention or according to the second independent aspect of the invention. The household refrigeration apparatus can be a refrigerator or a freezer or a combined refrigerator-freezer.

In addition, it can also be provided that the drink producing apparatus is formed for receiving a capsule, in which additives, which can be added to the mixed drink, are contained. Additives can be powdery or gelatinous or also liquid. In this context, the capsule can then be introduced into a dispensing area of the drink producing apparatus and this ingredient of the capsule can then also be automatically dispensed or admixed or already be admixed upon dispensing the mixed drink.

In an advantageous implementation, it is provided that the drink producing apparatus is disposed in a receiving area of the household refrigeration apparatus in particular separate from the receiving space for food. This receiving area can be formed in an interior container bounding the receiving space with its walls. However, it can also be provided that the receiving area is formed in an interior container separate from this interior container bounding the receiving space with its walls. These interior containers or this interior container are or is disposed in the housing.

The receiving space, in particular only the receiving space, is closable on the front side by a door pivotably supported at the housing. In this context, it can be provided that the household refrigeration apparatus is formed such that only one receiving space is present, which is for example a refrigerating compartment or a freezing compartment, which is closable by an own door. However, it can also be provided that such a single receiving space is closable by two doors, which are swing doors. However, it is similarly possible that with two separate receiving spaces, for example a refrigerating space and a freezing space, each of these receiving spaces is closable by a separate door.

Preferably, the drink producing apparatus is accessible on the front side and exposed and not closed and covered by a door.

In an advantageous implementation, it is provided that the drink producing apparatus is arranged drawer-like in the receiving space and thus is retractable and extractable in depth direction of the household refrigeration apparatus. Thereby, the operability for dispensing mixed drinks can be simplified. An essential advantage of this configuration is to be regarded in that the accessibility to the housing of the mixed drink producing apparatus is simplified. In particular the accessibility to the containers and/or other further components in the housing is thereby allowed. It can then be provided that in the extracted state the interior of the housing of the drink producing apparatus can be accessed for example via openings in side walls closable by flaps.

The drink producing apparatus is also to be referred to as mixed drink producing apparatus if the drink to be dispensed comprises at least one liquid and an addition medium or at least two different liquids.

With indications of “top”, “bottom”, “front”, “rear”, “horizontal”, “vertical”, “depth direction”, “width direction”, “height direction” etc., the positions and orientations with intended use and intended arrangement of the apparatus and with an observer then standing in front of the apparatus and looking towards the apparatus are specified.

Further features of the invention are apparent from the claims, the figures and the description of figures. The features and feature combinations mentioned above in the description as well as the features and feature combinations mentioned below in the description of figures and/or shown in the figures alone are usable not only in the respectively specified combination, but also in other combinations without departing from the scope of the invention. Thus, implementations are also to be considered as encompassed and disclosed by the invention, which are not explicitly shown in the figures and explained, but arise from and can be generated by separated feature combinations from the explained implementations. Implementations and feature combinations are also to be considered as disclosed, which thus do not have all of the features of an originally formulated independent claim. Moreover, implementations and feature combinations are to be considered as disclosed, in particular by the implementations set out above, which extend beyond or deviate from the feature combinations set out in the relations of the claims.

### BRIEF DESCRIPTION OF THE DRAWINGS

Below, embodiments of the invention are explained in more detail based on schematic drawings. There show:

FIG. 1 a perspective partial representation of an embodiment of a household refrigeration apparatus according to the invention;

FIG. 2 a schematic representation of partial components of an embodiment of a drink producing apparatus according to the invention as it can be installed in the household refrigeration apparatus according to FIG. 1; and

FIG. 3 a schematic representation of partial components of an embodiment of a drink producing apparatus according to the invention.

### PREFERRED EMBODIMENTS OF THE INVENTION

In the figures, identical or functionally identical elements are provided with the same reference characters.

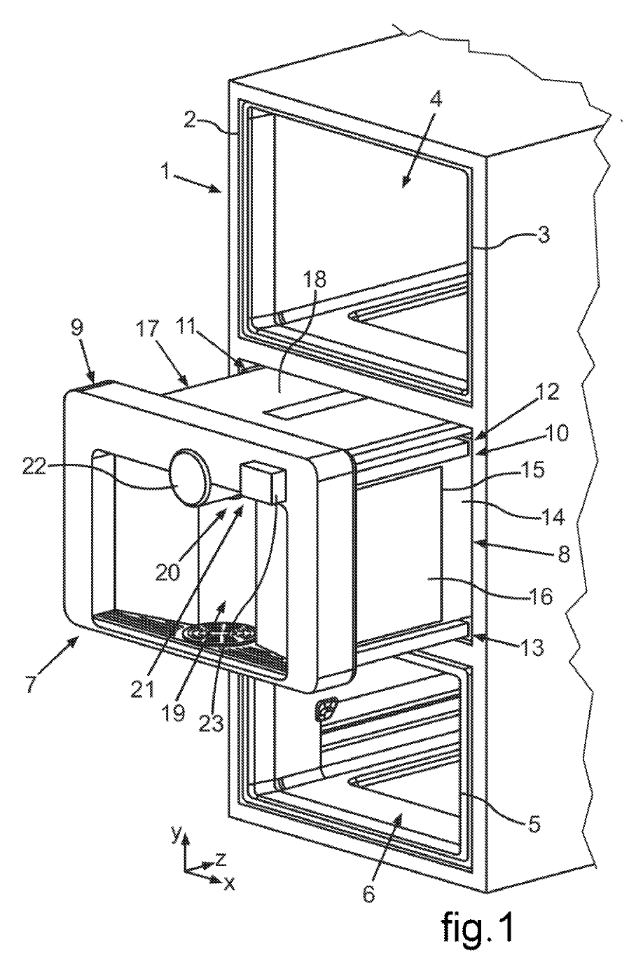

In FIG. 1, an embodiment of a household refrigeration apparatus 1 is illustrated in certain areas in a simplified perspective representation. Here, the household refrigeration apparatus 1 is for example a combined refrigerator-freezer, but can also be only a refrigerator or a freezer. The household refrigeration apparatus 1 is formed for storing and preserving food. It includes a housing 2, in which a first interior container 3 is disposed. Walls of the interior container 3 bound a first receiving space 4 for food, wherein this receiving space 4 is a refrigerating compartment.

Moreover, the household refrigeration apparatus 1 includes a further interior container 5, which bounds a second receiving space 6 with its walls, which is a freezing compartment. The two receiving spaces 4 and 6 are separated from each other. In the shown embodiment, the receiving spaces 4 and 6 are disposed one above the other in vertical direction and thus in height direction (y-direction). In the embodiment, they are preferably closable by non-shown, respectively separate doors, which are in particular pivotably fastened to the housing 2.

Moreover, the household refrigeration apparatus 1 includes a drink producing apparatus 7, which is a mixed drink producing apparatus in the embodiment.

However, the drink producing apparatus 7 can also be formed as a separate independent apparatus and thus be installed independently of a household refrigeration apparatus 1 and operable independently thereof.

The mixed drink producing apparatus 7 is disposed in a receiving area 8 of the housing 2. This receiving area 8 is separated from the receiving spaces 4 and 6. It can be provided that the receiving area 8 is bounded by walls of a separate interior container, which is also foamed in the housing 2. However, the receiving area 8 can also be formed integrated in the interior container 3 or the interior container 5.

In the embodiment, it is provided that the receiving area 8 is disposed between the receiving space 4 and the receiving space 6 in height direction.

The drink producing apparatus 7 is disposed accessible from the front side and thus from the front and the visible side. In particular, it is not closable and thus not coverable on the front side by a door.

The drink producing apparatus 7 comprises a housing 9.

In the embodiment, it is provided that the housing 9 and thus the entire mixed drink producing apparatus 7 can be extracted from and again retracted into the receiving area 8 in depth direction and thus in horizontal direction corresponding to the z-direction corresponding to a drawer. In FIG. 1, the completely extracted state is shown. However, the apparatus 7 can also be disposed fixedly installed.

Here, it is preferably provided that the horizontal displaceability is formed by a displacing device 10, which has multiple supporting positions. In the embodiment, it is provided that the displacing device 10 includes at least two, in particular four supporting positions. In the embodiment, they are formed as rails, which can also be extraction rails. In particular, here are disposed a first rail 11 in an upper left corner area, a second rail 12 in the upper right corner area, a third rail 13 in the lower right corner area and a further rail not recognizable in FIG. 1 in the lower left corner area. By this four-position support, a very secure and spread- and tilt-proof displacement, respectively, of the housing 9 is allowed.

Thus, the drink producing apparatus 7 is advantageously displaceably supported in the interior container 8. Advantageously, the displacing device 10 also comprises an extraction stop, by which the drink apparatus formed in particular as a drink producing apparatus 7 is secured in position in a completely extracted position shown in FIG. 1. Thus, over-extraction cannot be effected such that the drink producing apparatus 7 cannot fall out to the front and tilt downwards, respectively.

Advantageously, it is also provided that the displacing device 10 comprises a displacing protection, by which the drink producing apparatus 7 is disposed extraction-secured in the position completely retracted into the receiving area 8. Thereby too, undesired slipping out or protruding to the front then present is avoided. Undesired leakage or dripping of a liquid or hitting thereto is thereby prevented. This displacement protection can be a locking device. However, in addition or instead, a magnetic mount can for example also be provided.

Advantageously, an access 15 is formed at a vertical sidewall 14 of the housing 9, which is closed by a flap 16. After opening the flap 16, the interior of the housing 9 can be accessed such that the simple and unrestricted accessibility is allowed for purposes of exchange or filling. Additionally or instead, it can also be provided that a corresponding access is formed at an opposing further vertical sidewall 17 and/or at least one such access 15 is formed at a ceiling wall 18 of the housing 9.

Moreover, the drink producing apparatus 7 includes a recess or placing bay 19 on the front side, into which a drinking vessel can be placed, by which the mixed drink to be produced and dispensed by the drink producing apparatus 7 can then be collected. The drink producing apparatus 7 includes a dispensing unit 20 with in particular a single outlet or a dispensing opening 21. Preferably, it can be provided that an own outlet is respectively present for discharging each liquid from a container. Moreover, it can also be provided that an additive in powder form or gel form or further liquid form can additionally be admixed to this mixed drink to be produced, which can be produced and thus mixed from at least two different liquids. Thereto, it can in particular be provided that a capsule receptacle 22 is formed, into which a capsule comprising the mentioned additive or an addition medium can be inserted. Upon dispensing the mixed drink, this ingredient or additive is then removed from the capsule and added to the mixed drink in particular after dispensing into the drinking vessel effected via the dispensing opening 21.

Moreover, it can in particular be provided that the drink producing apparatus 7 comprises a capsule storage 23 or a capsule stock. A capsule or multiple capsules can be stored in this capsule storage 23 such that they are always present locally at the apparatus itself. In an advantageous implementation, it can be provided that this capsule storage 23 is cooled such that the capsules located therein can also be stored correspondingly cooled.

Preferably, it is provided that the capsule storage 23 can be opened by push-push mechanics and the capsules received therein are then freely accessible for example in the form of a displaceable storage in the form of a rail and for example can then be simply removed from above.

Moreover, it can also be provided that the drink producing apparatus 7 comprises a cartridge for admixing carbon dioxide into the mixed drink. Thereto, the accessibility for cartridge exchange is allowed via at least one present access 15. In an advantageous implementation, it is provided that the drink producing apparatus 7 is connected to a water connection external to household apparatus such that supply of water is for example allowed via a house water network. This has the additional advantage that a liquid to be added to the mixed drink as water does not have to be stored in a largely dimensioned container in the drink producing apparatus 7 but that this container can then be smaller dimensioned and can be refilled depending on demand and adapted to situation. It can then also be provided that such a water supply for producing the mixed drink is not supplied from the tank or the container provided for receiving this liquid in the drink producing apparatus 7, but additionally or instead can also be passed directly from this line to the dispensing unit 20 and thus also to the dispensing opening 21.

Thereby, in particular in production of hot drinks instead of a cold drink, the required energy for heating is reduced since the initial temperature of the water is higher. If carbonization of the mixed drink should then be desired, thus, this can be allowed via admixture of carbonized cold water, which is cooled in the drink producing apparatus 7, or by a carbonized second liquid, which is then present in the second container.

It is in particular provided that the drink producing apparatus 7 comprises a first container, in which a first liquid with a first freezing point, in particular water, is then provided or stored to then provide it for producing and dispensing a mixed drink depending on demand. Moreover, the drink producing apparatus 7 includes a second container separated therefrom, which is formed for receiving a second liquid different from the first liquid, which has a freezing point different form the first liquid. In particular, the first liquid is water and the second liquid is alcohol such that the mixed drink can also be an alcoholized mixed drink.

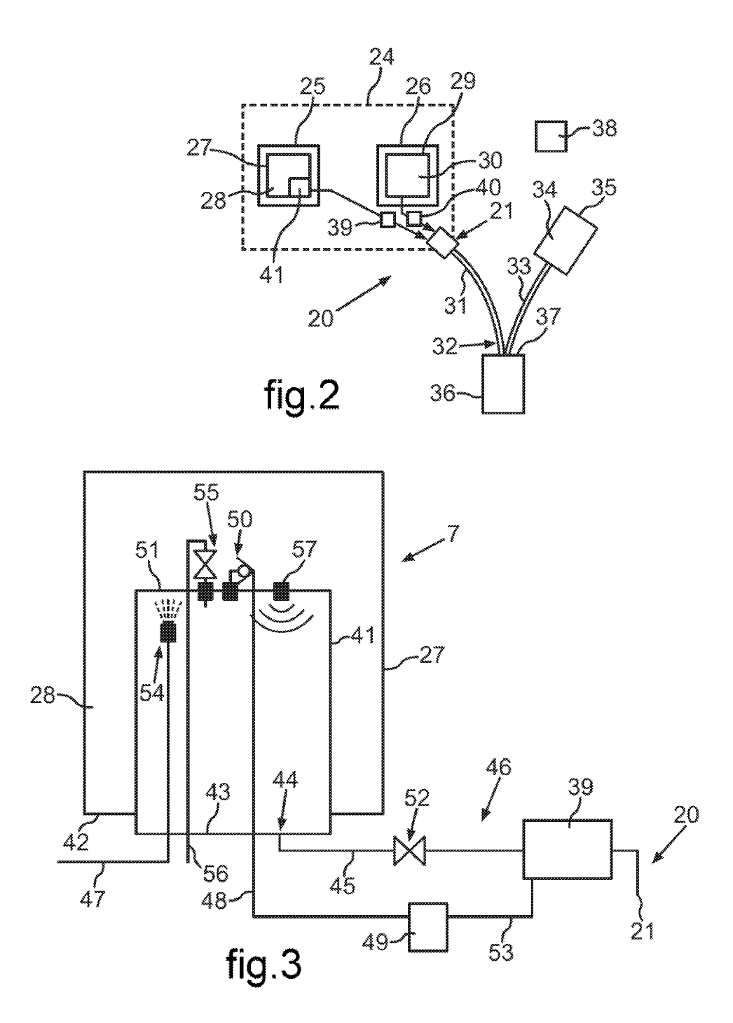

In FIG. 2, the household refrigeration apparatus 1 is shown with partial components of the drink producing apparatus 7 in a schematic representation. The household refrigeration apparatus 1 includes a refrigeration circuit 24, which is in particular a refrigeration circuit of the drink producing apparatus 7. In an advantageous implementation, this refrigeration circuit 24 includes a non-illustrated condenser, a compressor as well as a first evaporator 25 and a second evaporator 26 separate therefrom. The mixed drink producing apparatus 7 includes a first container or dispensing container 27, which is formed for receiving the first liquid 28 addable to the mixed drink, in the embodiment. The first dispensing container 27 is thermally coupled to the refrigeration circuit 24, in particular thermally coupled to the first evaporator 25. In an advantageous implementation, the first evaporator 25 surrounds the first dispensing container 27 on the outer side thereof at least in certain areas.

In the embodiment, it is provided that the drink producing apparatus 7 comprises a second container or dispensing container 29 separate from the first dispensing container 27, which is formed for receiving a second liquid 30 different from the first liquid, which can also be added to the mixed drink. Here too, it is preferably provided that the second evaporator 26 is thermally coupled to the second dispensing container 29, in particular surrounds it on the outer side thereof at least in certain areas.

In particular, it is provided that the first liquid 28 is or comprises water and the second liquid 30 is or contains alcohol.

In FIG. 2, dispensing of the two liquids 28 and 30 from the dispensing containers 27 and 29 is then illustrated by arrows in sketchy manner in the schematic representation, and the two liquids 28 and 30 are mixed to a common liquid jet 31 in an advantageous implementation. However, dispensing of a jet of only one of the two liquids 28 and 30 can also be provided.

In particular, it is provided that the jet 31 is formed after exit from the dispensing opening 21 at a place of meeting 32 with a jet 33 of an additive or addition medium 34, which is contained in a capsule 35 disposed in the mixed drink producing apparatus 7, after the dispensing opening 21, but before entry into a receiving vessel 36 with regard to the height position viewed in vertical direction. In particular, this place of meeting 32 is above a border 37 of the receiving vessel 36 in vertical direction. Mixing between the jet 31 and the jet 33 then desirably improved already before entry into the receiving vessel 36 is thereby achieved.

Therein, the receiving vessel 36 is placed in the placing bay 19 (FIG. 1).

The drink producing apparatus 7 also includes a control unit 38 for controlling the dispensing of the mixed drink.

In FIG. 2 it is preferably also provided that a decompression chamber 39 is arranged in the partial system, in which the first liquid 28 is stored and led. It is in particular arranged between the dispensing container 27 and the dispensing unit 20. The first liquid 28 then in particular carbonized is led into the decompression chamber 39 before leading out of the dispensing opening 21 and there reduced in its pressure. In particular, pressure reduction to about 3 bar is performed in the decompression chamber 39.

In an advantageous implementation, it is in particular provided that in addition or instead a further decompression chamber 40 is provided. It is arranged in the partial area or the system, in which the second liquid 30 is stored and led. It is correspondingly arranged between the further dispensing container 29 and the dispensing unit 20, in particular the dispensing opening 21. There too, if the second liquid 30 is provided in carbonized manner, pressure reduction can be effected in the decompression chamber 40, in particular also again preferably to a pressure of about 3 bar.

In FIG. 3, the drink producing apparatus 7 is shown with partial components in a schematic representation. The further explanation is exemplarily performed based on the partial system, in which the first liquid 28 is contained. A correspondingly identical construction can then also be provided via the further partial system, in which the further second liquid 30 is provided.

It is apparent that the drink producing apparatus 7 comprises a conditioning container 41 in addition to the dispensing container 27. The conditioning container 41 is arranged in the dispensing container 27 at least in certain areas. Thus, the conditioning container 41 is in external contact with the liquid 28 contained in the dispensing container 27 at least in certain areas. As is apparent, the conditioning container 41 protrudes outwards and downwards beyond a bottom 42 of the dispensing container 27. An outlet 44 is formed at a bottom 43 of the conditioning container 41. A line part 45 of a line device 46 of the drink producing apparatus 7 opens into this outlet 44. Moreover, a line part 47 of the line device 46 is shown in FIG. 3, which is connected to the dispensing container 27 and the conditioning container 41. The first liquid 28 is introduced from the dispensing container 27 into the conditioning container 41 via this line part 47. The liquid 28 is introduced in the dispensing container 27 in a first liquid state, which is a non-carbonized state. This liquid 28 is then conditioned into a second liquid state in the conditioning container 41, which is a carbonized state. Thereto, carbon dioxide is led from a carbon dioxide addition unit 49, which is a constituent of the drink producing apparatus 7, into the conditioning container 41 via a carbon dioxide line connection 48. The line connection 48 is connected to the conditioning container 41 via a valve 50, which is in particular a check valve. In particular, it is provided that the line connection 48 opens into the conditioning container 41 at a ceiling 51 of the conditioning container 41 via the valve 50.

Moreover, it is apparent that the line connection 45 opens into the decompression chamber 39 via a valve 52. The carbon dioxide addition unit 49 is also connected to the decompression chamber 39 via a line connection comprising a line part 53. Thus, pressure reduction of the pressure of the carbonized liquid to a value of about three bar can be effected in the decompression chamber 39.

As is apparent in the shown embodiment, a nozzle 54 can preferably be arranged at an end of the line part 47, by which the first liquid 28 can be sprayed into the conditioning container 41.

Moreover, the drink producing apparatus 7 comprises a further valve 55, which is in particular an electrically switchable valve. This valve 55 is connected to an exhaust line 56 such that gas present in the conditioning container 41 can be exhausted in the opened state of the valve 55. If the drink producing apparatus 7 is operated in a cleaning mode different from a conventional dispensing mode for dispensing a drink, thus, cleaning fluid is first filled into the conditioning container 41, in particular from the dispensing container 27 via the line device 47. Therein, the valve 55 is opened such that with increasing cleaning fluid in the conditioning container 41, the gas located therein is urged to the outside and can escape via the exhaust line 56. Here too, it is preferably provided that this exhaust line 56 opens at the ceiling 51 of the conditioning container 41. Moreover, the drink producing apparatus 7 comprises a filling level sensor 57, by which a filling level of the liquid in the conditioning container 41 can be captured. Thus, the filling level of the cleaning fluid in the conditioning container 41 can then also be captured in a cleaning mode. Preferably, the filling level sensor 57 is arranged at the ceiling 51. The filling level sensor 57 can for example be an ultrasonic sensor or an optical sensor like a laser.

Advantageously, it is provided that those partial areas of functional components, which extend from the conditioning container 41 into the dispensing container 27, are covered by one or more covers such that a preferably sealed positioning of these partial areas of the functional components is achieved here too. Functional components can be line parts for leading liquid. However, functional components can also be electrical components or mechanical components and can for example also be realized by the valves 50, 55 or the filling level sensor 57.

As is advantageously shown in FIG. 3, the line part 47 also opens into the bottom 43 and then extends into the conditioning container 41. In the cleaning mode, the valve 55 is in particular closed only just before reaching the maximum and thus complete filling of the conditioning container 41 with the cleaning fluid. By the arrangement of the dispensing container 27 and the conditioning container 41 arranged therein shown in FIG. 3, even with a relatively low filling level of the liquid 28 in the dispensing container 27, cooling of the conditioning container 41 by means of this cooled liquid 28 can be effected. In the cleaning mode, the cleaning fluid introduced into the conditioning container 41 is then led via the outlet 44 and the line connection 45 then also to the preferably present decompression chamber 39 such that it is also correspondingly purged and cleaned. By this configuration and the opening of the line connection 45 into the bottom 43 of the conditioning container 41, the cleaning fluid can then also be simply and reliably again completely drained from the conditioning container 41. This has substantial advantages to avoid undesired stay of remainders of the cleaning fluid in the conditioning container 41. A corresponding bottom-side opening of a drain line in the decompression chamber 39 can be provided. In particular, this can be the line connection, which extends from the decompression chamber 39 to the dispensing unit 20. Such a bottom-side opening at a bottom of the dispensing container 27 is preferably also formed for the line device 47.

### LIST OF REFERENCE CHARACTERS

1 Household refrigeration apparatus
2 housing
3 interior container
4 first receiving space
5 interior container
6 second receiving space
7 mixed drink producing apparatus
8 receiving area
9 housing
10 displacing device
11 rail
12 rail
13 rail
14 sidewall
15 access
16 flap
17 sidewall
18 ceiling wall
19 placing bay
20 dispensing unit
21 outlet
22 capsule receptacle
23 capsule storage
24 refrigeration circuit
25 first evaporator
26 second evaporator
27 first dispensing container
28 first liquid
29 second dispensing container
30 second liquid
31 jet
32 place of meeting
33 jet
34 addition medium
35 capsule
36 vessel
37 border
38 control unit
39 decompression chamber
40 decompression chamber
41 conditioning container
42 bottom
43 bottom
44 outlet
45 line part
46 line device
47 line part
48 carbon dioxide line connection
49 carbon dioxide addition unit
50 valve
51 ceiling
52 valve
53 line part
54 nozzle
55 valve
56 exhaust line
57 filling level sensor

1. Drink producing apparatus comprising:
a dispensing unit for dispensing liquid from the drink producing apparatus,
a dispensing container, which is formed for receiving a liquid addable to a drink by the drink producing apparatus in a first liquid state,
a conditioning container, in which the liquid can be conditioned into a second liquid state different from the first liquid state, wherein
the conditioning container is arranged in the dispensing container at least in certain areas,
the conditioning container comprises an outlet, which is formed for draining a liquid medium from the conditioning container, wherein
the outlet is formed at a bottom of the conditioning container.

2. Drink producing apparatus according to claim 1, comprising:
a dispensing mode, in which the liquid addable to the drink to be produced is contained in the dispensing container and in the conditioning container; and
a cleaning mode, in which a cleaning fluid is contained in the dispensing container and in the conditioning container.

3. Drink producing apparatus according to claim 1, wherein the conditioning container comprises an electrically switchable valve for exhausting a gas contained in the conditioning container during a cleaning mode of the drink producing apparatus.

4. Drink producing apparatus according to claim 2, wherein the electrically switchable valve is arranged in an exhaust line and the exhaust line opens into a ceiling of the conditioning container.

5. Drink producing apparatus according to claim 1, comprising:
a filling level sensor for capturing a filling level of a cleaning fluid in the conditioning container during a cleaning mode of the drink producing apparatus.

6. Drink producing apparatus according to claim 1, wherein the filling level sensor is an ultrasonic sensor.

7. Drink producing apparatus according to claim 1, wherein the filling level sensor is an optical sensor.

8. Drink producing apparatus according to claim 1, comprising:
a decompression chamber for pressure reduction of the liquid carbonized in the conditioning container, wherein the decompression chamber is connected to the conditioning container by a line part of a line device of the drink producing apparatus.

9. Drink producing apparatus according to claim 1, comprising:
a functional component, which is arranged at the conditioning container and which extends into the dispensing container, and
a cover, by which the functional component is covered in sealed manner in a partial area, which extends into the dispensing container.

10. Drink producing apparatus according to claim 1, comprising:
a line part, to which the dispensing container is connected for leading liquid from the dispensing container to the conditioning container, wherein the line part opens into the conditioning container at the bottom of the conditioning container.

11. Household refrigeration apparatus comprising a housing, in which a receiving space for food is formed, and comprising a drink producing apparatus comprising:
a dispensing unit for dispensing liquid from the drink producing apparatus,
a dispensing container, which is formed for receiving a liquid addable to a drink by the drink producing apparatus in a first liquid state,
a conditioning container, in which the liquid can be conditioned into a second liquid state different from the first liquid state, wherein
the conditioning container is arranged in the dispensing container at least in certain areas,
the conditioning container comprises an outlet, which is formed for draining a liquid medium from the conditioning container, wherein
the outlet is formed at a bottom of the conditioning container.

12. Method for cleaning a drink producing apparatus comprising the following steps of:
providing the drink producing apparatus with a dispensing unit for dispensing liquid from the drink producing apparatus in a dispensing mode of the drink producing apparatus, including
providing the drink producing apparatus with a dispensing container, which is formed for receiving a liquid addable to a drink by the drink producing apparatus in a first liquid state in a dispensing mode of the drink producing apparatus,
providing the drink producing apparatus with a dispensing container, in which the liquid can be conditioned into a second liquid state different from the first liquid state in a dispensing mode of the drink producing apparatus, wherein
the conditioning container is arranged in the dispensing container at least in certain areas,
setting a cleaning mode of the drink producing apparatus;
supplying a cleaning fluid into the drink producing apparatus;
completely filling the conditioning container with the cleaning fluid;
draining the cleaning fluid form the conditioning container via an outlet at a bottom of the conditioning container.

13. Method according to claim 12, wherein an electrically switchable valve is opened at the conditioning container and during filling the cleaning fluid into the conditioning container, it remains opened until the conditioning container is at least 95% filled with the cleaning liquid.

14. Method according to claim 13, wherein a filling level, which characterizes at least 95% of filling, is captured by a filling level sensor and the electrically switchable valve is closed depending on the capture of this filling level.
